(19) United States
(12) Patent Application Publication
(10) Pub. No.: US 2011/0315230 A1
(43) Pub. Date: Dec. 29, 2011

(54) METHOD AND APPARATUS FOR ACID GAS COMPRESSION

(75) Inventors: Konrad Roman Weeber, Rexford, NY (US); Massimo Camatti, Pistoia (IT)

(73) Assignee: General Electric Company, Schenectady, NY (US)

(21) Appl. No.: 12/826,393

(22) Filed: Jun. 29, 2010

(51) Int. Cl. G05D 16/20; G05D 7/06

(52) U.S. Cl. 137/14; 137/565.17; 137/565.29

(57) ABSTRACT

The present invention provides novel motor-compressor systems and methods useful for handling acid gas, by-produced produced in large quantities from natural gas refining. In one embodiment, a novel motor-compressor system comprises first compressor; a pressure vessel configured to receive a compressed gas from the first compressor; a heat exchanger coupled to the pressure vessel configured to cool the compressed gas and provide a cooled compressed gas; and an electric motor housed within the pressure vessel, wherein the electric motor is mechanically coupled to the first compressor, and wherein the pressure vessel is configured to receive at least a portion of the cooled compressed gas from the heat exchanger and contact the electric motor. The methods and systems described herein are particularly useful in acid gas re-injection operations where large quantities of acid gas are subjected to compression at high pressure and leakage prevention is critical.

### FIELD OF THE INVENTION

This invention relates generally to a motor-compressor system, and more specifically, to a motor-compressor system for acid gas compression.

### BACKGROUND OF THE INVENTION

Typically, gas extracted from natural gas reservoirs contains a high concentration of methane (CH₄), the principal hydrocarbon component of natural gas, and also contains a significant concentration of hydrogen sulfide (H₂S) and carbon dioxide (CO₂) gases. The extracted natural gas is refined to obtain relatively pure CH₄, which may be delivered through pipelines for residential and industrial use. The main by-product of the natural gas refining process is acid gas, which comprises principally a mixture of H₂S and CO₂ together with a variable amount of moisture. A standard industry practice has been to convert the acid gas mixture into elemental sulfur, a solid, gaseous CO₂ and water. The elemental sulfur is stored for later use or disposal and the CO₂ is discarded into the atmosphere. However, such standard industry practice presents challenges associated with the generation, storage and disposal of huge amounts of flammable elemental sulfur, a substance presenting serious environmental risks in the event of fire. The standard industry practice alluded to also results in the discharge of significant amounts of CO₂ into the atmosphere, subjecting practitioners to opprobrium among certain constituencies. Alternative schemes for dealing with by-product acid gas include re-injecting the acid gas mixture back into suitable subterranean geologic formations such as depleted natural gas reservoirs.

The acid gas re-injection process requires a compressor to provide the necessary head pressure to force the acid gas mixture into the suitable subterranean geologic formation. Typically, the compressors used for this purpose are multi-stage centrifugal compressors with operating pressures in the range of 100 to 200 bars. Such high pressures require high power and therefore, high speed electric motors are used to drive these compressors. However, high speed electric motors of this type typically generate large amounts of heat which must be managed in order to prevent damage to the motor itself and other affected components of the compressor system. Traditionally, several types of cooling systems have been used to cool high speed electric motors. For example, a process gas itself, or a component thereof, may be used to cool a high speed electric motor associated with a compressor acting upon the process gas. However, the efficiency of such cooling systems is apt to suffer due to factors such as windage losses.

In acid gas re-injection operations, the gas mixture which must be compressed prior to re-injection is hazardous due to the high concentration of H₂S, which typically makes up between 25% and 65% of the mixture. Although H₂S is ubiquitous in nature due to an abundance of non-anthropogenic sources (for example, bacteria, thermal vents, volcanoes and hot springs), it is relatively toxic at higher concentrations. Large scale acid gas re-injection, involves handling significant amounts of hydrogen sulfide at high pressures and adequate precautions must be taken to avoid adventitious release of the acid gas mixture into the atmosphere, to avoid danger to re-injection plant personnel and the environment. As a result, new, reliable and safer systems for the compression of acid gas are needed.

Accordingly, the present invention provides a number of solutions to these and other challenges associated with acid gas re-injection. In one aspect, the present invention provides specific motor-compressor system configurations useful for the integration of one or more high speed electric motors with one or more compressors which may be used for acid gas compression.

### BRIEF DESCRIPTION OF THE INVENTION

In one embodiment, the present invention provides a method for compressing an acid gas mixture, said method comprising: (a) compressing a gas mixture comprising hydrogen sulfide and carbon dioxide to provide a compressed gas mixture at a first pressure in a range from about 5 bar to about 20 bar, said compressed gas mixture comprising from about 10 to about 95 percent by volume hydrogen sulfide and from about 90 to about 5 percent carbon dioxide, said hydrogen sulfide and said carbon dioxide together being present in an amount corresponding to from about 90 to about 100 percent by weight of a total weight of the compressed gas mixture, said compressing being carried out in a first compressor, said first compressor being coupled to a pressure vessel configured to receive the compressed gas mixture; (b) cooling the compressed gas mixture formed in step (a) to a temperature in a range from about 20° C. to about 50° C. to provide a cooled compressed gas mixture; and (c) contacting at least a portion of the cooled compressed gas mixture with a first electric motor, said first electric motor being housed within the pressure vessel, said first electric motor being mechanically coupled to the first compressor.

In an alternate embodiment, the present invention provides system comprising: a first compressor; a pressure vessel configured to receive a compressed gas from the first compressor; a heat exchanger coupled to the pressure vessel configured to cool the compressed gas and provide a cooled compressed gas; and an electric motor housed within the pressure vessel, wherein the electric motor is mechanically coupled to the first compressor, and wherein the pressure vessel is configured to receive at least a portion of the cooled compressed gas from the heat exchanger and contact the electric motor.

In yet another embodiment, the present invention provides a system comprising: a first multi-stage centrifugal compressor configured to introduce a compressed gas stream into a pressure vessel defining a compressed gas flow path; a heat exchanger coupled to the pressure vessel configured to cool the compressed gas and provide a cooled compressed gas; an electric motor housed within the pressure vessel and mechanically coupled to the first multi-stage centrifugal compressor, wherein the electric motor is configured to be contacted by at least a portion of the cooled compressed gas; and a second multi-stage centrifugal compressor mechanically coupled to an electric motor housed within the pressure vessel and configured to be contacted by at least a portion of the cooled compressed gas, wherein the second multi-stage centrifugal compressor is configured to compress the cooled compressed gas.

Other embodiments, aspects, features, and advantages of the invention will become apparent to those skilled in the art from the following detailed description, the accompanying drawings, and the appended claims.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an embodiment of the invention featuring an electric motor housed within a pressure vessel and mechanically coupled to a compressor;

FIG. 2 is a schematic representation of a motor-compressor system with a single high speed electric motor mechanically coupled to two compressors, according to an illustrative embodiment of the invention;

FIG. 3 is a schematic representation of a motor-compressor system with two high speed electric motors each mechanically coupled to separate compressors, according to an illustrative embodiment of the invention;

FIG. 4A is a plot of temperature versus entropy of the overall compression process depicted in either FIG. 2 or FIG. 3;

FIG. 4B is a plot of temperature versus pressure of the overall gas compression process depicted either FIG. 2 or FIG. 3; and

FIG. 5 is a flowchart illustrating a method for achieving efficient cooling of an electric motor, in accordance with an illustrative embodiment of the invention.

The drawings themselves are not drawn to scale and the actual relative sizes of the components featured in the drawings may be different than depicted herein.

### DETAILED DESCRIPTION OF THE INVENTION

The present invention provides methods and systems for gas compression which are particularly useful for compressing an acid gas mixture. At the outset, it should be noted that acid gas mixtures requiring compression for re-injection are typically highly toxic gas mixtures containing significant amounts of hydrogen sulfide. Moreover, the pressures required to achieve the efficient re-injection of acid gas mixtures into deep and secure geologic formations, are sufficiently elevated to require stringent measures to prevent adventitious release of the acid gas being processed by a surface re-injection unit. Typically, an acid gas re-injection unit comprises a series of compressors driven by high speed electric motors. In one aspect, the present invention addresses the need to control and eliminate the escape of process gases from acid gas re-injection units by locating the high speed motor used to drive the gas compressor inside a pressure vessel configured to receive the compressed acid gas from the compressor. Such a configuration reduces reliance on seals between the motor and the compressor since leakage across any such seals would take place within the confines of the pressure vessel itself. A disadvantage of incorporating the high speed motor within the pressure vessel is that the compressed gas produced by the compressor and being introduced into the pressure vessel is relatively hot and is corrosive toward a variety of components of a typical high speed electric motor. As will be apparent to those of ordinary skill in the art after reading this disclosure, the present invention provides novel systems and methods which reduce reliance on seals between the compressor and its drive motor while protecting the drive motor from the corrosive effects of the acid gas being processed.

High speed electric motors generate significant amounts of heat during operation, and when disposed within a confined space, are typically provided with a cooling system to prevent damage to the motor due to high operating temperatures. The placement of the electric motor within the pressure vessel, while providing a significant advantage in terms of gas leak prevention, poses additional challenges in terms of controlling the temperature of the electric motor during operation. An external cooling system might be integrated to the pressure vessel, but this feature would add additional cost and complexity to the system. The present invention addresses the need to cool the high speed electric motor disposed within the pressure vessel and uses the process gas itself, after appropriate treatment, to do so.

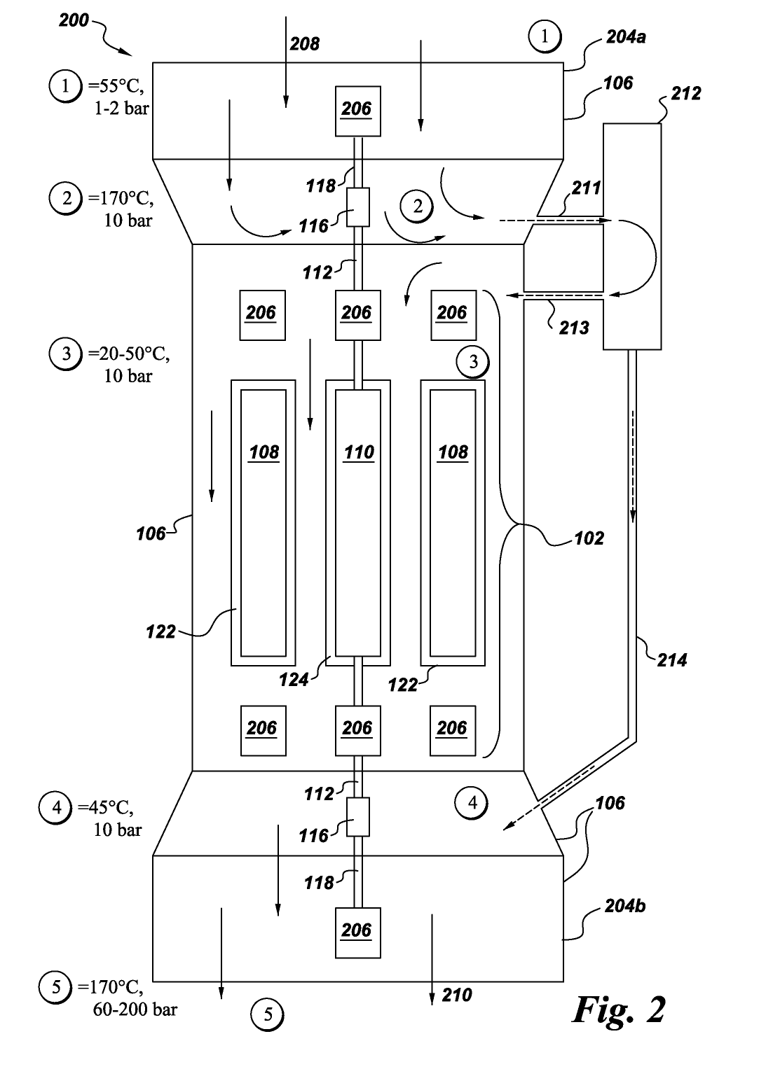

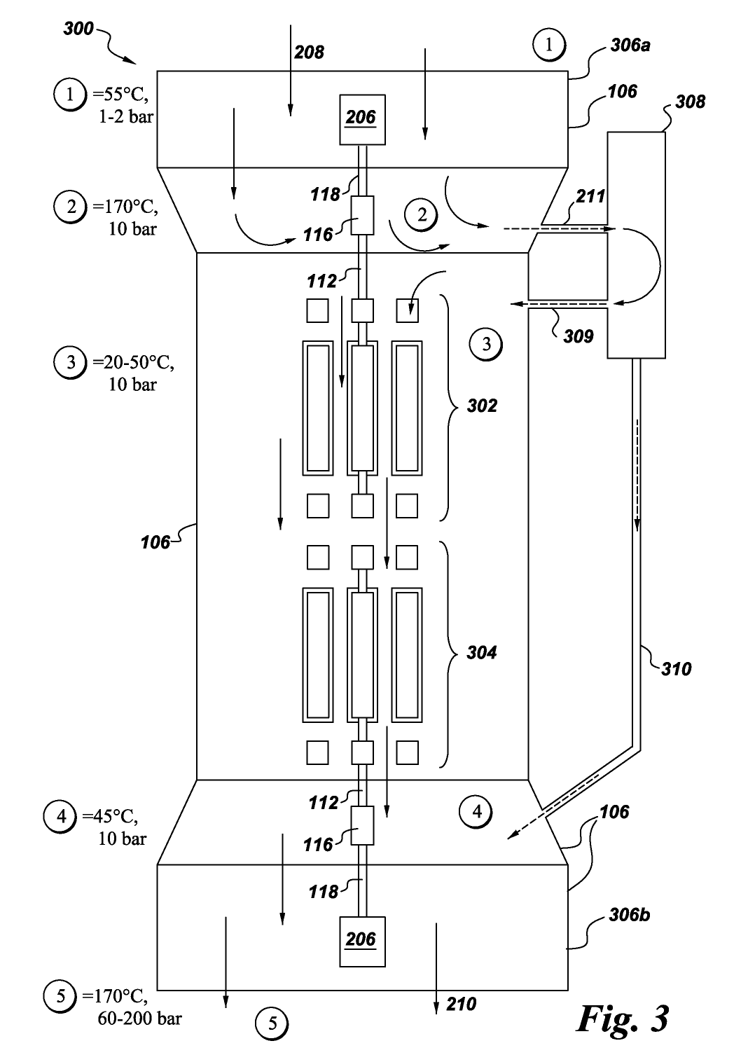

As noted, the first compressor is driven by a high speed electric motor disposed within (also referred to as “housed within”) the pressure vessel itself. The electric motor is configured to drive the first compressor and is said to be mechanically coupled to the first compressor. As used herein, the term “mechanically coupled” includes within its meaning the condition of coupled components being co-rotatable by rotating a first coupled component and effecting rotation of a second coupled component thereby. In addition, the term “mechanically coupled” includes the condition where two or more components are configured for coupling but are not actually coupled to one another, as would be the case in which an end portion of a drive shaft 112 (See for example FIG. 2) is fixed within a first portion of a coupling element 116 by a first set of coupling element set screws, and an end portion of a rotor 118 is disposed within a second portion of the same coupling element 116 possessing a second set of coupling element set screws, the set screws being configured to be tightened in order to fix the end portion of the rotor 118 within the second portion of the coupling element 116. However, the second set of coupling element set screws has not yet been tightened, and the end portion of the rotor 118 may rotate freely within the second portion of the coupling element 116 without causing either the coupling element 116 or drive shaft 112 to rotate. The term “mechanically coupled” therefore includes configurations wherein a drive shaft 112 and a rotor 118 are configured to be coupled by a detachable coupling element 116 and the coupling element has been removed. In one embodiment, a rotor of the first compressor is mechanically coupled to a rotor of the electric motor. Various types of mechanical couplings are illustrated herein; see for example FIG. 2 and FIG. 3. The electric motor disposed within the pressure vessel is typically a high speed electric motor which operates at rotation rates of from about 3000 to about 15000 revolutions per minute (rpm). In one embodiment, the high speed electric motor is a permanent magnet electric motor. In one embodiment, the first compressor is a multi-stage centrifugal compressor.

In various embodiments of the present invention, a compressed gas mixture produced by a first compressor coupled to a pressure vessel is directed through a flow path defined within the pressure vessel to a heat exchanger where the compressed gas is cooled to provide a cooled compressed gas. Another function of the heat exchanger is to remove moisture from the compressed gas. Those of ordinary skill in the art will understand that gas mixtures such as acid gas, may be especially corrosive in the presence of moisture. Thus, in one embodiment, the heat exchanger comprises a compressed gas cooling unit and separate water knock-out unit. In an alternate embodiment, the heat exchanger comprises a unitary structure which both cools the compressed gas while removing water from it. In various embodiments of the present invention, the heat exchanger is used to treat essentially all of the compressed gas produced by the first compressor, and in turn produces a cooled compressed gas which is substantially free of water. The cooled compressed gas emerging from the heat exchanger is characterized by a pressure which is about the same as the compressed gas produced by the first compressor (from about 5 bar to about 20 bar), but has a temperature substantially cooler than the compressed gas produced by the first compressor. In one embodiment, the cooled compressed gas has a temperature in a range from about 20° C. to about 50° C. The heat exchanger may be located within the pressure vessel or outside of the pressure vessel. In either configuration, the heat exchanger forms part of a gas flow path for the gas being treated.

At least a portion of the cooled compressed gas is then brought into contact with the electric motor disposed within the pressure vessel. The electric motor is located within a gas flow path defined by the pressure vessel and at least a portion of the cooled compressed gas is directed along this flow path and into contact with the electric motor. In various embodiments, the direction of flow and the mass of the cooled compressed gas contacting the electric motor may be controlled by a fan which may be remote from, attached to, or integrated into the electric motor. The cooled compressed gas contacts various components of the electric motor and removes heat from them. The cooled compressed gas having absorbed heat from electric motor then travels further along the flow path defined by the pressure vessel and out of contact with the electric motor.

In various embodiments of the present invention, only a portion of the cooled compressed gas contacts the electric motor and the remaining cooled compressed gas is directed by an alternate flow path to a location within the pressure vessel downstream of the electric motor, see for example zone 4 illustrated in FIG. 2, where it is reunited with cooled compressed gas having contacted the electric motor. The recombined cooled compressed gas output of heat exchanger is then further compressed to a pressure suitable for efficient re-injection of the acid gas into a secure geologic formation. In one embodiment, this step of further compressing the recombined cooled compressed gas output of heat exchanger provides a further compressed gas characterized by a pressure in a range from about 60 bar to about 200 bar and a temperature of up to 170° C. In one embodiment, this step of further compressing the recombined cooled compressed gas output of heat exchanger is carried out using a second compressor driven by the same high speed electric motor used to drive the first compressor. Thus, a single first electric motor mechanically coupled to both the first compressor and the second compressor may be used to drive both compressors. In an alternate embodiment, a second electric motor likewise disposed within the pressure vessel is mechanically coupled to and drives the second compressor. In one embodiment, the second compressor is a multi-stage centrifugal compressor. In an alternate embodiment, both the first compressor and the second compressor are multi-stage centrifugal compressors.

As noted, in one embodiment, the present invention provides a method for compressing a gas mixture comprising hydrogen sulfide (H₂S) and carbon dioxide (CO₂). An initial gas mixture comprising hydrogen sulfide and carbon dioxide is compressed by a first compressor which is coupled to a pressure vessel. With respect to the first compressor, the expression “coupled to a pressure vessel” means that the output of the first compressor, a “compressed gas stream” or simply a “compressed gas mixture”, is directed into the pressure vessel. The pressure vessel is said to be configured to receive the compressed gas from the first compressor.

Typically the gas mixture being compressed contains from about 10 to about 95 percent by volume hydrogen sulfide and from about 90 to about 5 percent carbon dioxide, and the compressed gas mixture necessarily comprises about the same percent by volume of hydrogen sulfide and carbon dioxide. Typically the amount of hydrogen sulfide and carbon dioxide in either the initial gas mixture or the compressed gas mixture, together corresponds to from about 90 to about 100 percent by weight of the total weight of the compressed gas mixture. In one embodiment, the gas mixture to be compressed (the initial gas mixture) comprises from about 20 to about 70 percent by weight hydrogen sulfide. The initial gas mixture may contain water and hydrocarbons such as methane, ethane, propane, and like gases present in natural gas. As the initial gas mixture is compressed from an initial temperature and pressure, typically from about ambient temperature to about 60° C. and from about 1 to about 2 bar, the temperature of the compressed gas is significantly increased. In one embodiment, the gas mixture being compressed by the first compressor increases in temperature from about 60° C. to about 170° C. as the pressure is increased from about 1 bar to about 10 bar.

In one embodiment, a first compressor compresses an initial acid gas mixture to provide a first compressed gas having a temperature of from about 60° C. to about 170° C. and a pressure of about 10 bar. This first compressed gas is introduced into a pressure vessel and directed to a heat exchanger where it is cooled to a temperature in a range from about 20° C. to about 50° C. to provide a cooled compressed gas mixture. At least a portion of the cooled compressed gas mixture is contacted with a first electric motor disposed within the pressure vessel and mechanically coupled to the first compressor.

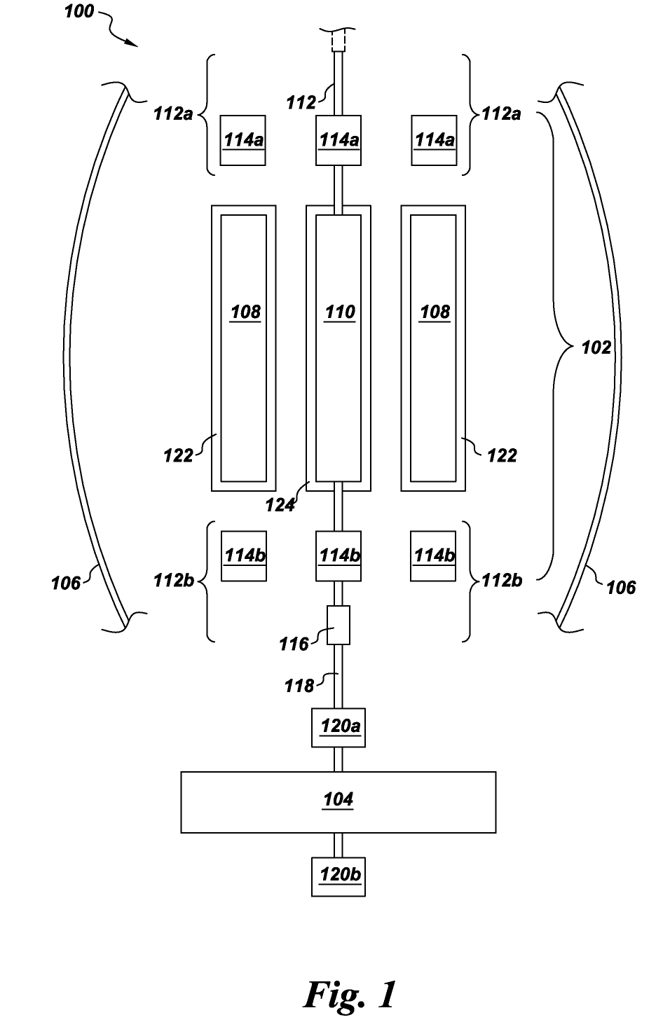

FIG. 1 is a partial view in cross section of an electric motor 102 integrated with (mechanically coupled to) a compressor 104, according to an embodiment of the invention. The embodiment illustrated in FIG. 1 shows a part of a motor-compressor system 100 (hereinafter interchangeably referred to as system 100), wherein an electric motor 102 housed within a pressure vessel 106 is integrated with a compressor 104. The electric motor 102 is located between two compressors: a first compressor (not shown in figure) located at the inlet side of the electric motor 102, and a second compressor 104 located at the exit side of the electric motor 102. In various embodiments of the invention, the first compressor and the second compressor 104 may be single or multi-stage centrifugal compressors.

Referring to FIG. 1, the electric motor 102 includes a stator 108 and a rotor 110. In an embodiment of the invention, the rotor 110 may be a permanent magnet rotor, and the electric motor 102 may be an Alternating Current (AC) synchronous motor. In another embodiment, the AC synchronous motor may not require an exciter. Furthermore, the rotor 110 may form a part of a drive shaft 112, which is rotatably journalled at both the ends: a first end 112a and a second end 112b by magnetic bearings 114a and 114b respectively. These magnetic bearings reduce power loss by minimizing the wear and tear in rotating shafts that operate over an extended period of time. The drive shaft 112 is further connected longitudinally via a coupling element 116 to a rotor 118 of the second compressor 104. The rotor 118 is rotatably journalled within the magnetic bearings 120a and 120b.

During non-steady-state operation of the motor-compressor system 100, for example during a fast start-up and loading regime, different components of the system 100 experience different levels of vibration. As a result, the different components of the system 100, for example, the second compressor 104 and the electric motor 102, experience skewed axes of rotation with respect to each other, and thus generate a bending moment in the coupling element 116. In an embodiment of the invention, the coupling element 116 may include one of a Hirth coupling element or a rigid coupling element to make the coupling element 116 longitudinally stiff and able to accommodate bending moments. In one embodiment, the Hirth coupling or rigid coupling is designed such that all serrations are precisely machined with an orientation to the centerline of shafts so that the individual shafts are stiff longitudinally and free to rotate radially in a self-centering manner relative to one another. As a result, neither the rotor 118 nor the drive shaft 112 is overstressed during operation. Additionally, the Hirth or the rigid coupling element is much easier to assemble and disassemble compared to an axially flexible coupling element. Apart from the design aspects involved for a flexible integration of the electric motor 102 with the second compressor 104, the configuration of the system 100 also necessitates robustness in design to handle the abrasive nature of the acid gas mixture in contact with various components of the system 100.

The presence of H₂S in the acid gas mixture being processed places restrictions on the materials that can be used for components of the electric motor 102 because many metals are sensitive to sulfide stress cracking. To protect the various components of the electric motor 102 from the corrosive effects of the gas mixture, the stator 108 may be enclosed in an encapsulation unit 122. In the exemplary embodiment shown in FIG. 1, the encapsulation unit 122 is a hermetic can. Similarly, the rotor 110 may also be sealed against the corrosive and abrasive effects of the acid gas mixture by encasing a Halbach array of magnets (not shown) in a corrosion resistant casing 124. In one embodiment, the Halbach array of magnets forms a part of the rotor 110 of the electric motor 102, and is a special arrangement of permanent magnets that augment the magnetic field on one side of the rotor 110 and cancel the field to almost zero on the other side. Thus, in an embodiment of the invention, the configuration and design of the motor-compressor system 100 may be governed by the composition and properties of the acid gas mixture. Moreover, the configuration and design of the system 100 may be based on the level of pressure to be applied to the gas mixture as it flows through the motor-compressor system 100.

Where the system 100 is being used to re-inject acid gas into a deep and secure geologic formation, the head pressure required at the surface re-injection unit are typically in a range of from about 60 bar to about 200 bar, depending on the requirements associated with the particular geologic formation. As noted, large head pressures typically require the use of high speed electric motors. In various embodiments disclosed herein the electric motor 102 (hereinafter interchangeably referred to as high speed electric motor 102) rotates at very high speeds, typically in a range of 3000-15000 rpm, to provide the necessary power to the second compressor 104 and in this process may generate a significant amount of heat in the windings of the stator 108. Accordingly, to cool the windings on the inside of the stator 108, the encapsulation unit 122 may contain electric insulating oil (not shown). The electric insulating oil not only cools, but also provides electrical insulation between the internal components of the stator 108. Even at relatively high temperatures, the electrical insulating oil should remain stable, without flaring for an extended period of operation.

The stator 108 and other components of the electric motor are cooled by a compressed acid gas flow through the electric motor 102. In one embodiment, to protect the encapsulation unit 122 against leakage, the encapsulation unit 122 is designed to maintain a differential pressure between the electric insulating oil and the compressed acid gas flowing through the electric motor 102. In one embodiment, the electric insulating oil is kept at a slightly higher pressure than the compressed acid gas, so that in case of leakage, the electric insulating oil may flow outwardly from the inside of the encapsulation unit 122 and thus prevent accidental absorption of H₂S into the encapsulation unit 122. Moreover, the pressure of the electric insulating oil keeps the stator 108 and the electrical windings secure from corrosive and abrasive effects of the acid gas mixture.

Further referring to FIG. 1, in an embodiment of the invention, the pressure vessel 106, which houses the electric motor 102, can be extended to include the complete motor-compressor system 100. Due to the high concentration of H₂S in the acid gas mixture to be compressed, one of the objectives of the illustrated configuration of the motor-compressor system 100 is to prevent the leakage of the acid gas mixture into the atmosphere. Accordingly, the pressure vessel 106 encloses the electric motor 102 and prevents leakage through seals which would be required if compressor system were driven by an external electric motor. In one embodiment, the compressed acid gas mixture received by the pressure vessel 106 from the first compressor is at an optimal first pressure (i.e., a pressure that yields maximum efficiency of cooling of the electric motor 102 by the acid gas mixture).

FIG. 2 is a schematic representation of a motor-compressor system 200 comprising a single high speed electric motor 102 mechanically coupled to two compressors 204a and 204b, according to an illustrative embodiment of the invention. In the exemplary embodiment shown in FIG. 2, the motor-compressor system 200 includes a first compressor 204a, disposed in serial flow communication with a high speed electric motor 102, and with a second compressor 204b. In the exemplary embodiment, both the first compressor 204a and the second compressor 204b are two-stage centrifugal compressors. In one embodiments of the invention, the first and second compressors 204a and 204b are multi-stage centrifugal compressors. The first compressor 204a and the second compressor 204b are mechanically coupled to the high speed electric motor 102 via two coupling elements 116. The rotor 110 of the high speed electric motor 102 and the rotors 118 of the first compressor 204a and the second compressor 204b are mechanically coupled to drive shaft 112 and are supported on a plurality of magnetic bearings 206. The pressure vessel 106 houses the high speed electric motor 102 and maintains a constant pressure inside it. The pressure is optimized such that the acid gas mixture demonstrates efficient cooling properties in the electric motor 102. In an embodiment of the invention, the pressure vessel 106 may house the complete motor-compressor system 200.

Use of the acid gas mixture as a coolant for the high speed electric motor 102 lends compactness to the motor-compression system 200 by removing the need for a separate cooling system. This also improves the cooling efficiency in the electric motor 102 by reducing windage losses. The windage losses may become significant when a separate cooling system is used because continuous recirculation of the coolant may be required in such a system. The use of acid gas mixtures as a coolant in the system 200 necessitates the integration of the high speed electric motor 102 with the compressors 204a and 204b in a configuration different from the typical configuration used in integrated motor-compressor systems. The nature of the acid gas mixture accordingly makes it necessary to discharge the compressed acid gas mixture into the pressure vessel at a first pressure and temperature range suitable for achieving the maximum cooling efficiency of the electric motor 102 disposed within the pressure vessel.

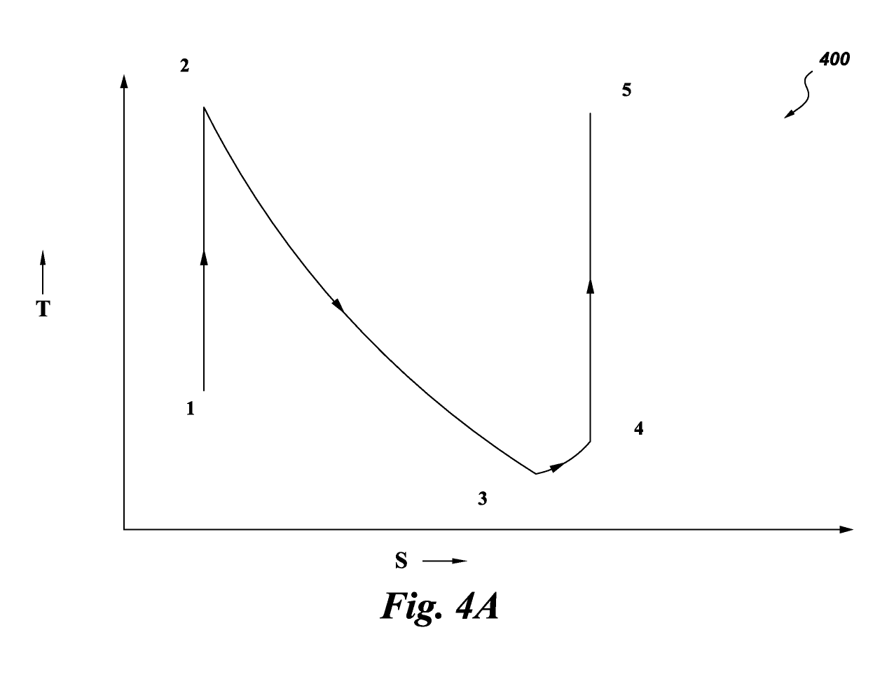

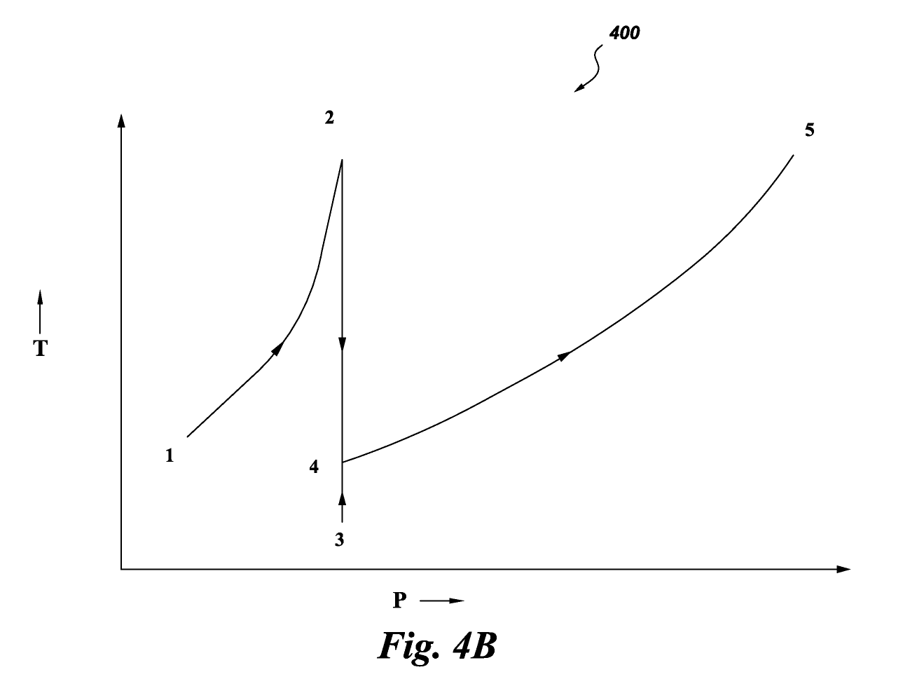

As the acid gas mixture flows through the motor-compressor system 200, different components of the system 200 act on it at different stages in the compression process. The gas undergoing compression passes through a continuum of states starting from an initial state of the acid gas mixture presented to the first compressor at inlet 208 and ending at a final state of the gas exiting the second compressor at outlet 210. The state of the acid gas mixture may be defined by the pressure, temperature and/or entropy of the mixture at a particular stage of the compression process. Under steady state conditions, each location along the gas flow path through the motor-compressor system will be characterized by a state which will remain constant while steady state conditions prevail. Although there are potentially a very large number of locations and associated states within the gas flow path through the motor-compressor system it is convenient to denote zones within the gas flow path where approximately the same conditions of pressure, temperature and/or entropy prevail. The zones and their approximate states of the acid gas mixture may be denoted by numerals 1-5 shown in FIG. 2, FIG. 3, FIG. 4A, and FIG. 4B Thus, the numerals 1-5 may also refer to a zone within or adjacent the motor-compressor system wherein the acid gas mixture being processed has a particular temperature, pressure and entropy. For example, in the exemplary embodiment shown in FIG. 2, state 1 refers to the state of the acid gas mixture at an inlet 208 of the first compressor 204a and state 5 refers to the state of the acid gas mixture at an outlet 210 of the second compressor 204b.

During operation of the system 200, the acid gas mixture is fed into the motor-compressor system from an external processing plant (not shown in the figure) that separates the acid gas mixture from natural gas. The inlet 208 receives the acid gas mixture from the external processing plant, the acid gas mixture being characterized by a state 1. The pressure and temperature of the state 1 is typical of the refining process in the external processing plant, from which the acid gas mixture is obtained and are typically in a range from about 1 to about 2 bar and approximately 55° C. respectively. The acid gas mixture is subsequently compressed by the first compressor 204a to a first pressure and temperature characterized by a state 2 which state corresponds approximately to a location in the motor-compressor system corresponding to zone 2 in FIG. 2. In an embodiment of the invention, the first pressure may be in a range from about 5 bar to about 20 bar. The compressed acid gas mixture gains heat during the compression by the first compressor and may reach a temperature as high as 170° C. Therefore, the acid gas mixture is at a higher pressure and temperature in state 2 than in state 1. Thereafter, the hot compressed acid gas mixture is directed by the flow path defined by the pressure vessel to a heat exchanger 212 coupled to the pressure vessel 106 via conduit 211. In the embodiment shown in FIG. 2, the heat exchanger 212 comprises a cooling unit and a water knock-out unit. In one embodiment, the cooling unit of the heat exchanger 212 cools the hot compressed acid gas mixture from a temperature of approximately 170° C. in state 2 to a temperature in a range from about 20° C. to about 50° C. in state 3/zone 3. The water knock-out unit removes moisture present in the acid gas mixture. The removal of moisture from the acid gas mixture reduces the corrosiveness of the acid gas mixture to the high speed electric motor 102 and other components of the motor-compressor system 200. Thus, the acid gas mixture contacts the electric motor 102 motor at a suitably cool temperature for efficient cooling of the electric motor. In addition, because water has been removed from the acid gas mixture, the possibility of moisture condensation inside the electric motor 102 is greatly reduced. Typically, a first portion of the acid gas passing through heat exchanger is directed to electric motor 102 via gas return conduit 213. Acid gas returned through the return conduit is contacted with motor 102 which is located in zone 3 and thereby serves to cool the motor. A second portion of acid gas may pass via by-pass conduit 214 and into the inlet side of the second compressor 204b located in zone 4.

As noted, in one embodiment, after being cooled by the heat exchanger 212, the acid gas mixture, now characterized by state 3, contacts the electric motor 102 at a pressure in a range from about 5 bar to about 20 bar and a temperature in a range from about 20° C. to about 50° C. The encapsulated stator 108 and the rotor 110 and other components of the electric motor 102 are cooled by the acid gas mixture, which may be guided around the encapsulated stator 108 and the rotor 110. The pressure inside the pressure vessel may be controlled to provide for the most efficient cooling of electric motor 102 by the acid gas mixture. As noted, the carbon dioxide present in the acid gas mixture may vary in concentration from about 5 percent to about 90 percent by volume of the acid gas mixture. Generally, gaseous carbon dioxide is a poor heat removal medium and as such the effectiveness of the acid gas in removing heat from the electric motor may vary inversely with the concentration of carbon dioxide in the acid gas. However, by exercising temperature and pressure control of the acid gas mixture coming into contact with the electric motor, the heat removal capacity/cooling efficiency of the acid gas mixture may be optimized for a particular acid gas composition. The cooling efficiency in the electric motor 102 may be defined as the ratio of the heat extracted by the acid gas mixture from the electric motor 102 to the work done by the first compressor stage 204a on the acid gas mixture. For most acid gas mixtures encountered in acid gas re-injection operations, a good tradeoff between the poor heat removal capacity of carbon dioxide present in the acid gas mixture and the work done by the first compressor 204a may be achieved at a pressure in a range of from about 5 bar to about 20 bar, and a temperature in a range from about 20° C. to about 50° C. Therefore, in the configuration of the integrated motor-compressor system 200, the first compressor 204a may be operated to provide the first compressed gas at a pressure which is optimal to effect the cooling of the electric motor 102 with greatest efficiency. As will be appreciated by those of ordinary skill in the art, the heat exchanger may be configured and operated in order to provide a cooled compressed gas having a temperature in a desired temperature range.

The cooled compressed gas absorbs heat as it cools the electric motor and thereafter passes into zone 4 where it is reunited with cooled compressed gas entering zone 4 via by-pass conduit 214. The cooled compressed gas in zone 4 is characterized by state 4 wherein, in the embodiment shown, the pressure is approximately 10 bar and the temperature is approximately 45° C. The cooled compressed gas in zone 4 is then further compressed by second compressor 204b. The compressed acid gas mixture exiting the second compressor 204b at the outlet 210 of the motor-compressor system 200, is characterized by a final state 5, wherein, in the embodiment shown, the pressure is in a range from about 60 bar to about 200 bar, and wherein the temperature is approximately 170° C.

Typical acid gas re-injection operations involve the compression of large quantities acid gas and are characterized by high power requirements. Typically, the power required by a compressor in a motor-compressor system varies as the cube of the mass flow rate of the acid gas mixture flowing through the compressor. Therefore, a relatively small change in the mass flow rate may change the power requirement significantly. To meet the varying power requirements in the motor-compressor system 200, the high speed electric motor 102 can be configured to drive the compressors 204a and 204b relatively high efficiency. Thus, the high speed electric motor 102 may be part of a frequency control circuit (not shown in figure) to match the variable power requirements of the compressors 204a and 204b. Typically, motor-driven systems are designed to handle peak loads with an additional safety factor built in. This often leads to energy use inefficiency in systems that operate for extended periods of time at a reduced load. The ability to adjust motor speed enables closer matching of motor output to load and saves energy. In this exemplary embodiment, the operating speed of the high speed electric motor 102 may be varied by changing the frequency of the motor supply voltage, thus allowing an accurate and continuous process control over a wide range of speeds. In an embodiment of the invention, the high speed electric motor 102 is designed to provide 15 MW of power. More than one high speed electric motor 102 may be used in applications that require more power. Such a configuration is detailed in the discussion of FIG. 3 which follows.

FIG. 3 is a schematic representation of a motor-compressor system 300 comprising two high speed electric motors 302 and 304 mechanically coupled to compressors 306a and 306b respectively, according to an illustrative embodiment of the invention. In the exemplary embodiment shown in FIG. 3, a motor-compressor system 300 consists of a first compressor 306a in serial flow communication with a first high speed electric motor 302 such at least a portion of the gas compressed by the first compressor contacts the motor after appropriate treatment by heat exchanger 308. A second compressor 306b in is said to be serial flow communication with a second high speed electric motor 304.

Still referring to FIG. 3, the gas flow path defined by the pressure vessel 106 and allied components of the motor-compressor system 300 (conduit 211, heat exchanger 308, return conduit 309, by-pass conduit 310) is shown by arrows starting at inlet 208 of the first compressor 306a, traversing the first compressor, being directed in zone 2 to conduit 211 leading to heat exchanger 308. A cooled compressed gas treated by the heat exchanger is returned to zone 3 of the pressure vessel 106 via return conduit 309 where it contacts the first electric motor 302 and the second electric motor 304. The cooled compressed gas having contacted both electric motors passes into zone 4 where it is reunited with cooled compressed gas entering zone 4 via by-pass conduit 310. The gas mixture in zone 4 is characterized by state 4 wherein the gas temperature is slightly elevated (in this example 45° C.) relative to the temperature in zone 3 due to the heat removed from electric motors 302 and 304. The gas mixture characterized by state 4 is then further compressed by the second compressor 306b and exits the motor-compressor system 300 at the outlet 210 of the second compressor in state 5.

In one embodiment, the first compressor 306a and the second compressor 306b may be single or multi-stage centrifugal compressors. In the exemplary embodiment shown in FIG. 3, the first compressor 306a may be a two-stage centrifugal compressor, while the second compressor 306b may be a three-stage centrifugal compressor. The first compressor 306a and the second compressor 306b may be coupled to the first high speed electric motor 302 and the second high speed electric motor 304 respectively by rigid or flexible coupling elements 116. However, in the embodiment shown in FIG. 3 the rotor of the first electric motor 302 is not coupled to the rotor of the second electric motor 304. This configuration allows the first compressor 306a and the second compressor 306b to operate at different speeds. In the exemplary embodiment shown in FIG. 3, both the first electric motor 302 and the second electric motor 304 may be equipped with frequency control circuits (not shown in figure) and hence are capable of meeting the varying power requirements of the first compressor 306a and the second compressor 306b respectively, resulting in significant energy savings. Moreover, in the embodiment shown in FIG. 3, a smaller number of magnetic bearings may be required to support the rotors because of the absence of a coupling between the rotors of the first and the second electric motors 302 and 304. Therefore, the exemplary embodiment illustrated in FIG. 3 is believed to represent a low cost and energy efficient architecture that copes with high power requirements of the motor-compressor system 300. The operation of the motor compressor system 300 is similar to the motor-compressor system 200 wherein the first compressor 306a compresses the acid gas mixture to a first pressure in an appropriate pressure range for optimum cooling efficiency of the electric motors 302 and 304. The initial acid gas mixture heats up when compressed by the first compressor 306a and subsequently passes through a heat exchanger 308 coupled to the pressure vessel 106 via conduits 211, 309 and 310. The heat exchanger 308 cools the compressed acid gas mixture and also removes moisture from the acid gas mixture. A portion of the cooled compressed acid gas mixture treated by heat exchanger 308 is then returned to the pressure vessel 106 via return conduit 309 and contacts the electric motors 302 and 304 before being discharged to the inlet side of second compressor 306b in zone 4. The acid gas mixture is then further compressed by second compressor 306b. The compressed acid gas mixture exits the motor-compressor system 300 via outlet 210 and wherein, in one embodiment, the acid gas exiting the system is characterized by a state 5 wherein the temperature may be as high as 170° C. and the pressure is in a range from about 60 to about 200 bar.

In an alternate embodiment, to that illustrated in FIG. 3, the heat exchanger 308 may be disposed within the pressure vessel 106. In this embodiment also, a portion of the acid gas passing through the heat exchanger 308 contacts each of the electric motors 302 and 304, the gas initially contacting electric motor 302 being characterized by state 3 (i.e. a temperature of about 40° and a pressure of about 10 bar). The remaining portion of the acid gas may be directed via a by-pass conduit 310 (or other alternate flow path not bringing the gas into contact with electric motors 302 and 304) to the inlet side of the second compressor 306b.

FIG. 4A is a plot of temperature versus entropy for an acid gas compression process 400 carried out in a motor-compressor system such as 200 (FIG. 2) or 300 (FIG. 3). In FIG. 4a the entropies and temperatures associated with the various stages of the overall compression process are given as relative values and are not intended in any way limit the scope of the process illustrated. Relative temperature is plotted on the vertical axis and relative entropy on the horizontal axis. The entire compression process may be defined by the states of the acid gas mixture and states 1-5 identified in FIG. 4a correspond to states 1-5 shown in FIGS. 2 and FIG. 3, wherein state 1 refers to the state of the acid gas mixture at the inlet 208 of the motor-compressor system; state 5 refers to the state of the acid gas mixture at the exit 210 of the motor-compressor system; and states 2, 3 and 4 refer to intermediate states of the acid gas mixture inside the motor-compressor system.

If reference is made to FIG. 2 when examining the plot shown in FIG. 4A, the acid gas mixture starts at the state 1 having a temperature of 55° C. The acid gas mixture is then compressed isentropically by the first compressor 204a from the state 1 (T=55° C.) to the state 2 (T=170° C.), which has the same entropy but a higher temperature. Thereafter, the compressed acid gas mixture is directed to the heat exchanger 212 where the mixture is cooled isobarically from the state 2 (T=170° C.) to the state 3 (T=40° C.). State 3 has higher entropy but a lower temperature than at the state 2. The cooled compressed acid gas mixture having state 3 is subsequently contacted with the electric motor 102. The acid gas mixture cools the electric motor 102 nearly isobarically and reaches the state 4 (T=45° C.), which has a higher temperature and higher entropy than the state 3. The mixture is subsequently fed to the second compressor 204b where the acid gas mixture is isentropically compressed to the final state 5 (T=170° C.), which has the same entropy but a higher temperature than the state 4.

FIG. 4B is a plot of temperature versus pressure for the same acid gas compression process 400 shown in FIG. 4A carried out in a motor-compressor system such as 200 (FIG. 2) or 300 (FIG. 3). In FIG. 4B the pressures and temperatures associated with the various stages of the overall compression process are given as relative values and are not intended in any way limit the scope of the process illustrated. Relative temperature is plotted on the vertical axis and relative pressure on the horizontal axis. The entire compression process may be defined by the states of the acid gas mixture and states 1-5 identified in FIG. 4B correspond to states 1-5 shown in FIG. 2 and FIG. 3, wherein state 1 refers to the state of the acid gas mixture at the inlet 208 of the motor-compressor system; state 5 refers to the state of the acid gas mixture at the exit 210 of the motor-compressor system; and states 2, 3 and 4 refer to intermediate states of the acid gas mixture inside the motor-compressor system.

If reference is made to FIG. 2 when examining the plot shown in FIG. 4B, the compression of the acid gas mixture starts at the state 1 (P=1-2 bar, T=55° C.). The acid gas mixture is then compressed isentropically by the first compressor 204a to the state 2 (P=10 bar, T=170° C.). The compressed acid gas mixture is then directed to the heat exchanger 212, wherein the mixture is cooled isobarically from the state 2 (P=10 bar, T=170° C.) to the state 3 (P=10 bar, T=40° C.). The cooled compressed acid gas mixture is subsequently passed through the electric motor 102. The acid gas mixture cools the electric motor 102 nearly isobarically and reaches the state 4 (P=10 bar, T=45° C.). The mixture is subsequently fed to the second compressor 204b, where the acid gas mixture is isentropically compressed to the final state 5 (P=60-200 bar, T=170° C.).

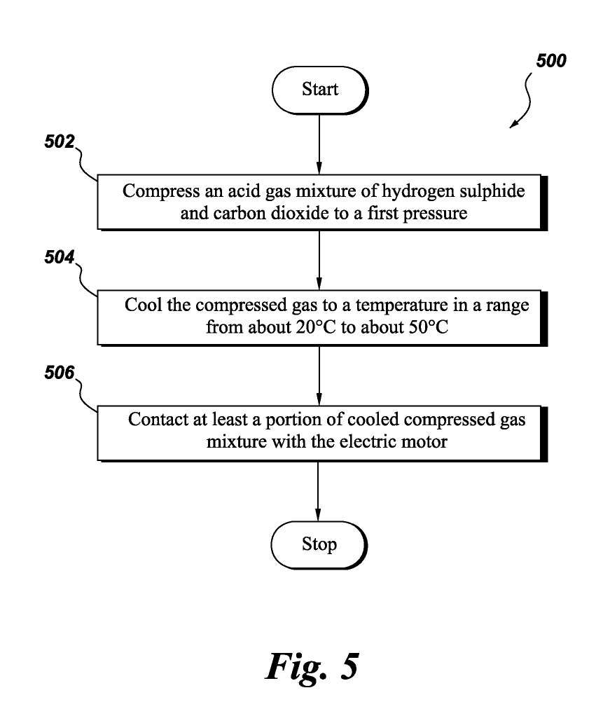

FIG. 5 is a flowchart illustrating a method 500 for achieving efficient cooling of an electric motor used to drive a first compressor and a second compressor in a motor-compressor system configured as in FIG. 2, in accordance with an illustrative embodiment of the invention.

The method 500 begins at block 502 wherein an initial acid gas mixture comprising hydrogen sulfide and carbon dioxide is compressed to a first pressure. The acid gas mixture comprising from about 10 to about 95 percent by volume of hydrogen sulfide and from about 90 to about 5 percent by volume of carbon dioxide is isentropically compressed by a first compressor to the first pressure in a range from about 5 bar to about 20 bar. Maximum cooling efficiency of an electric motor by an acid gas mixture may achieved in the when the acid gas is contacted with the electric motor at a pressure in a range from about 5 bar to about 20 bar. Thus the first compressor provides the necessary head pressure to the acid gas mixture for the efficient cooling of the electric motor used to drive the first compressor. Following the compression of the acid gas mixture to the optimum pressure range at block 502, the method step corresponding to block 504 is carried out.

At block 504, the compressed gas mixture formed at block 502 is cooled to a temperature in a range from about 20° C. to about 50° C. The gas mixture compressed at block 502 is directed through a heat exchanger. The heat exchanger may comprise two units: a cooling unit that cools the hot compressed acid gas mixture to a temperature in the approximate range from about 20° C. to about 50° C., and a water knock-out unit that removes moisture from the hot compressed acid gas mixture. Both the cooling process and the water removal process take place isobarically and the resultant cooled compressed gas emerges from the heat exchanger at a pressure in a range from about 5 bar to about 20 bar. Cooling the hot compressed acid gas mixture to the appropriate temperature range of 20° C.-50° C. improves the cooling efficiency of the cooled compressed gas in the electric motor, while the removal of moisture from the acid gas mixture makes the acid gas mixture less corrosive.

In block 506 at least a portion of the cooled gas mixture is contacted with the electric motor. Windage losses may occur as the cooled compressed acid gas mixture contacts with the electric motor. By limiting the amount of cooled compressed gas which contacts the components of the electric motor, windage losses may be controlled and minimized. When contact between the cooled compressed acid gas mixture and the electric motor is carried out under isobaric conditions at a temperature in a range from about 20° C. to about 50° C., a reasonable tradeoff between electric motor windage losses and electric motor cooling can be achieved.

The motor-compressor system disclosed in the application is specifically configured to compress an acid gas mixture and also to use the compressed acid gas mixture as a coolant for cooling a motor. The corrosive nature of the acid gas mixture coupled with its poor heat removal capacity makes it difficult for the existing motor-compressor configurations to achieve a high cooling efficiency. The motor-compressor systems disclosed herein enable safe and efficient handling of acid gas mixtures generated during natural gas refining. methods of obtaining an optimum state of the cooled compressed gas mixture at which the maximum cooling efficiency of the electric motor by the gas mixture can be achieved. Further, the use of a pressure vessel to enclose the electric motor prevents any possibility of a leakage of the acid gas mixture in spite of the high pressures involved in the process.

It will be apparent to a person skilled in the art that the values ranges given in the above embodiment are only for exemplary purposes and does not intend to limit or deviate the scope of the invention.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for compressing an acid gas mixture, said method comprising:
(a) compressing a gas mixture comprising hydrogen sulfide and carbon dioxide to provide a compressed gas mixture at a first pressure in a range from about 5 bar to about 20 bar, said compressed gas mixture comprising from about 10 to about 95 percent by volume hydrogen sulfide and from about 90 to about 5 percent carbon dioxide, said hydrogen sulfide and said carbon dioxide together being present in an amount corresponding to from about 90 to about 100 percent by weight of a total weight of the compressed gas mixture, said compressing being carried out in a first compressor, said first compressor being coupled to a pressure vessel configured to receive the compressed gas mixture;
(b) cooling the compressed gas mixture formed in step (a) to a temperature in a range from about 20° C. to about 50° C. to provide a cooled compressed gas mixture; and
(c) contacting at least a portion of the cooled compressed gas mixture with a first electric motor, said first electric motor being housed within the pressure vessel, said first electric motor being mechanically coupled to the first compressor.

2. The method according to claim 1, wherein said first compressor is a multi-stage centrifugal compressor.

3. The method according to claim 1, wherein said gas mixture comprises from about 20 to about 70 percent by weight hydrogen sulfide.

4. The method according to claim 1, wherein said first electric motor is operated at a speed of from about 3000 to about 15000 rpm.

5. The method according to claim 1, further comprising a step (d) wherein at least a portion of the compressed gas mixture cooled in step (b) and at least a portion of the cooled compressed gas mixture contacted with the electric motor in step (c) are further compressed to a pressure in a range from about 60 bar to about 200 bar.

6. The method according to claim 5, wherein said first electric motor drives a second compressor used in step (d).

7. The method according to claim 6, wherein said second compressor is multi-stage centrifugal compressor.

8. The method according to claim 5, wherein a second electric motor drives a second compressor used in step (d).

9. A system comprising:
a first compressor;
a pressure vessel configured to receive a compressed gas from the first compressor;
a heat exchanger coupled to the pressure vessel configured to cool the compressed gas and provide a cooled compressed gas; and
an electric motor housed within the pressure vessel, wherein the electric motor is mechanically coupled to the first compressor, and wherein the pressure vessel is configured to receive at least a portion of the cooled compressed gas from the heat exchanger and contact the electric motor.

10. The system according to claim 9, wherein said first compressor is a multi-stage centrifugal compressor.

11. The system according to claim 9, wherein said heat exchanger comprises a cooling unit and a water knock-out unit.

12. The system according to claim 9, wherein said electric motor is a permanent magnet electric motor.

13. The system according to claim 9, wherein said electric motor comprises a frequency control circuit to match variable power requirements of the first compressor.

14. The system according to claim 9, further comprising a coupling element disposed within the pressure vessel, wherein the coupling element connects a rotor of the first compressor to a rotor of the electric motor.

15. The system according to claim 9, further comprising a second compressor integrated with the electric motor at an exit side of the pressure vessel.

16. The system according to claim 15, wherein the second compressor is a multi-stage centrifugal compressor.

17. The system according to claim 15, wherein said electric motor comprises a frequency control circuit to match variable power requirements of the first and second compressors.

18. The system according to claim 15, further comprising a coupling element disposed within the pressure vessel, wherein the coupling element connects a rotor of the second compressor to a rotor of the electric motor.

19. The system according to claim 18, wherein the coupling element is a flexible coupling.

20. The system according to claim 18, wherein the coupling element is a Hirth coupling.

21. A system comprising:
a first multi-stage centrifugal compressor configured to introduce a compressed gas stream into a pressure vessel defining a compressed gas flow path;
a heat exchanger coupled to the pressure vessel configured to cool the compressed gas and provide a cooled compressed gas;
an electric motor housed within the pressure vessel and mechanically coupled to the first multi-stage centrifugal compressor, wherein the electric motor is configured to be contacted by at least a portion of the cooled compressed gas; and
a second multi-stage centrifugal compressor mechanically coupled to an electric motor housed within the pressure vessel and configured to be contacted by at least a portion of the cooled compressed gas, wherein the second multi-stage centrifugal compressor is configured to compress the cooled compressed gas.

22. The system according to claim 21, wherein the first multi-stage centrifugal compressor and the second multi-stage centrifugal compressor are mechanically coupled to a single electric motor housed within the pressure vessel.

23. The system according to claim 21, wherein the first multi-stage centrifugal compressor is mechanically coupled to a first electric motor housed within the pressure vessel, and the second multi-stage centrifugal compressor is mechanically coupled to a second electric motor housed within the pressure vessel.

24. The system according to claim 21, wherein the heat exchanger comprises a compressed gas cooling unit and a water knock-out unit.

25. The system according to claim 21, wherein the electric motor comprises an encapsulation unit enclosing a stator of the electric motor, wherein the encapsulation unit comprises a hermetic can.
